(19) United States
(12) Patent Application Publication
(10) Pub. No.: US 2016/0029841 A1
(43) Pub. Date: Feb. 4, 2016

(54) RAISED EDGE GRILL GRATE

(71) Applicant: Jeffrey D. Walker, Ortonville, MI (US)

(72) Inventor: Jeffrey D. Walker, Ortonville, MI (US)

(21) Appl. No.: 14/880,266

(22) Filed: Oct. 11, 2015

Related U.S. Application Data
(63) Continuation-in-part of application No. 13/495,227, filed on Jun. 13, 2012, now Pat. No. 9,215,950.
(60) Provisional application No. 62/062,926, filed on Oct. 12, 2014.

(51) Int. Cl. A47J 37/07

(52) U.S. Cl. CPC A47J 37/0763

(57) ABSTRACT

A raised edge grill grate is provided that includes an outer edge dowel that extends near a perimeter of the grill grate, a plurality of rods extending generally horizontally and generally parallel to one another and intersecting the outer edge dowel of the grill grate, the plurality of rods positioned such that there is sufficient space between the plurality of rods to support food and cooking vessels over a heating element, at least one raised edge dowel that extends near the outer edge dowel of the grill grate and is positioned a distance above the outer edge dowel to capture the food and the cooking vessels on the grill grate, a plurality of posts that extend generally vertically from the outer edge dowel and fixedly connect the outer edge dowel to the at least one raised edge dowel and wherein the at least one raised edge dowel extends partially around the perimeter of the grill grate to create an opening.

### CROSS REFERENCE TO RELATED APPLICATIONS

This patent application claims the benefit of priority based on a continuation-in-part of U.S. patent application Ser. No. 13/495,227 filed on Jun. 13, 2012, which is incorporated by reference in its entirety for all purposes and claims the benefit of priority based on U.S. Provisional Patent Application No. 62/062,926 filed on Oct. 12, 2014, which is incorporated by reference in its entirety for all purposes.

### STATEMENT REGARDING FEDERALLY SPONSORED RESEARCH OR DEVELOPMENT

Not Applicable

### INCORPORATION-BY-REFERENCE OF MATERIAL SUBMITTED ON COMPACT DISC

Not Applicable

### BACKGROUND OF THE INVENTION

1. Field of the Invention

The present invention relates generally to a grill grate capable of supporting food, cooking vessels and the like over a heating source, such as a flame or fire, during the cooking or heating process of solid or liquid food or beverages, and more particularly, to a grill grate that includes a partial raised edge to ensure that the food, cooking vessels and the like are maintained on the grill grate and positioned over the heating source while allowing for ease of cooking utensil use to position food or beverages while maintained on the grill grate.

2. Background Art

Campfires have been used to cook and heat food and liquids for thousands of years. Typically, a campfire may be started on the ground or earth with wood, charcoal, paper, leaves, and other items for fuel, oxygen and an igniter such as a match. When the fire reaches an appropriate temperature to cook food or heat liquids, a grill or grate may be place over the fire. The grill grate may be sized such that any type of meat, vegetable, cooking vessel, pot, coffee pot, etc., may be placed on the grill for heating to a desired temperature for eating or drinking

Cooking with a grill grate over an open fire is often done so outdoors and open to the elements of wind, rain and the like. Ground sites selected to construct a campfire and set up a cooking location may not be completely level thus causing the grill grate to tilt from one side of the grill grate to another. Perhaps, at the end of a long day camping or hiking, precious daylight hours may be dwindling as the sun sets and finding a suitable level ground location for a cooking fire may not be possible. If a cooking or campfire is built on a ground location that is not level, one may level the grill grate itself over the heating source. This has the drawback of uneven heating of the grill because of the different heights of the grill grate over the heat source. Both of these situations, an unleveled grill grate or level grill grate over unleveled ground may hinder cooking food and heating liquids on the grill grate.

Many of the food items that are cooked on a grill grate over an open flame or other heat source are generally cylindrical or round in shape thus allowing the items to roll easily about the grill grate. These items may include hot dogs or frankfurters, any type of sausage such as Italian, Polish, bratwurst, knockwurst and the like, and many vegetables such as corn, onions, peppers, tomatoes and the like. The cylindrical or round nature of the food may enable the food to roll from one side of the grill grate to another. If the grill grate is not level, often food may roll off the grill grate and onto the ground or into the fire thus rendering the food inedible. Even if the grill grate is level, an errant movement by the chef may knock the food item off the grill grate onto ground or into the fire or a gust of wind may pick up to actually blow the cylindrical or round food item off the grill grate onto the ground or into the fire.

Often, a cooking vessel, such as a campfire pot, Dutch oven, coffee pot and the like, are used to cook items that may not be adaptable to cooking on a grill with open slots. Those items may include stew, beans, soup, any liquids such as coffee and the like. In order to sufficiently heat or cook theses items, a cooking vessel such as one of those mentioned above may be used.

If the grill grate is not suitably level to support these cooking vessels, the vessels themselves may slide from one side of the grill grate to another and even off the grill thus spilling whatever is into the vessel onto the ground or into the fire thus rendering the food or liquid inedible. Furthermore, as food and liquids are removed from the vessels, the vessels will lighten in weight and tend to slide more easily off the grill grate if the grill grate is out of level.

Therefore, a need exists for a grill grate having a raised or partially raised edge at the perimeter of the grill grate. The raised edge will ensure food and cooking vessels are captured on the grill grate during the cooking process while allowing for the full use of cooking utensils with the food items or cooking vessels positioned on the grill grate.

### BRIEF SUMMARY OF THE INVENTION

A raised edge grill grate is provided that includes an outer edge dowel that extends near a perimeter of the grill grate, a plurality of rods extending generally horizontally and generally parallel to one another and intersecting the outer edge dowel of the grill grate, the plurality of rods positioned such that there is sufficient space between the plurality of rods to support food and cooking vessels over a heating element, at least one raised edge dowel that extends near the outer edge dowel of the grill grate and is positioned a distance above the outer edge dowel to capture the food and the cooking vessels on the grill grate, a plurality of posts that extend generally vertically from the outer edge dowel and fixedly connect the outer edge dowel to the at least one raised edge dowel and wherein the at least one raised edge dowel extends partially around the perimeter of the grill grate to create an opening.

### BRIEF DESCRIPTION OF THE SEVERAL VIEWS OF THE DRAWINGS

The features and inventive aspects of the present invention will become more apparent from the following detailed description, claims, and drawings, of which the following is a brief description:

FIG. 1A is perspective view of a portable grill assembly according to an embodiment of the present invention;

FIG. 1B is a perspective view of a raised edge grill grate according to an embodiment of the present invention;

FIG. 2A is perspective view of a portable grill assembly according to another embodiment of the present invention;

FIG. 2B is a perspective view of a raised edge grill grate according to another embodiment of the present invention;

FIG. 2C is front view of the portable grill assembly of FIG. 2A according to an embodiment of the present invention;

FIG. 2D is a top view of the raised edge grill grate of FIG. 2B according to an embodiment of the present invention;

FIG. 2E is a bottom view of the raised edge grill grate of FIG. 2B according to an embodiment of the present invention;

FIG. 2F is a first side view of the raised edge grill grate of FIG. 2B according to an embodiment of the present invention;

FIG. 2G is a second side view of the raised edge grill grate of FIG. 2B according to an embodiment of the present invention;

FIG. 3A is an exploded view of a mounting stake of the raised edge grill grate according an embodiment of the present invention;

FIG. 3B is a cross-sectional view of a coupler of FIG. 3A of the mounting stake of the raised edge grill grate according to an embodiment of the present invention;

FIG. 3C is a cross-sectional view of the coupler and a top segment and a bottom segment of the mounting stake of the raised edge grill grate according to an embodiment of the present invention;

FIG. 4 is perspective view of a raised edge grill grate according to yet another embodiment of the present invention;

FIG. 5A is perspective view of a raised edge grill grate according to still another embodiment of the present invention;

FIGS. 5B-5E are side views of the raised edge grill grate of FIG. 5A according to an embodiment of the present invention;

FIG. 6A is perspective view of a raised edge grill grate according to another embodiment of the present invention;

FIG. 6B is perspective view of a raised edge grill grate according to still another embodiment of the present invention;

FIG. 6C is perspective view of a raised edge grill grate according to yet another embodiment of the present invention;

FIG. 6D is perspective view of a raised edge grill grate according to still further another embodiment of the present invention; and

FIGS. 6E-6G are perspective views of the raised edge grill grate of FIG. 5B according to an embodiment of the present invention.

### DETAILED DESCRIPTION OF THE INVENTION

Referring now to the drawings, preferred illustrative embodiments of the present invention are shown in detail. Although the drawings represent embodiments of the present invention, the drawings are not necessarily to scale and certain features may be exaggerated to better illustrate and explain the present invention. Further, the embodiments set forth herein are not intended to be exhaustive or otherwise to limit or restrict the invention to the precise forms and configurations shown in the drawings and disclosed in the following detailed description.

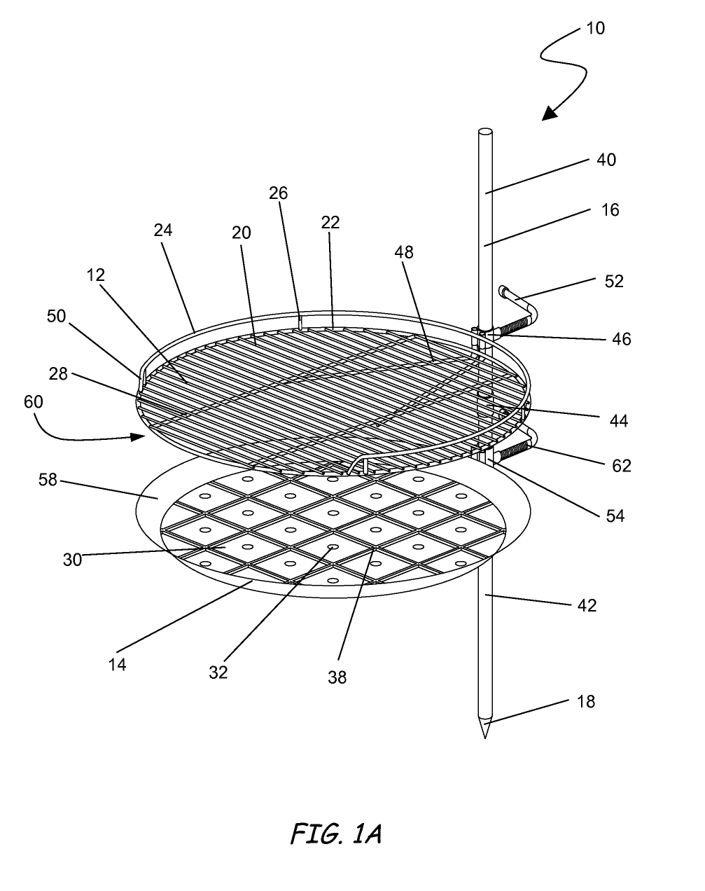

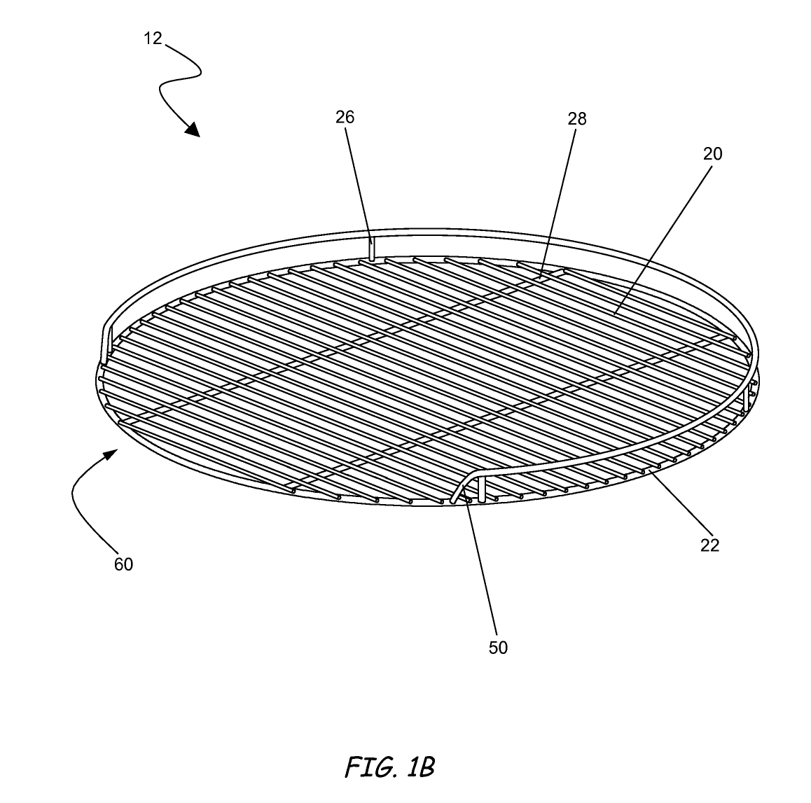

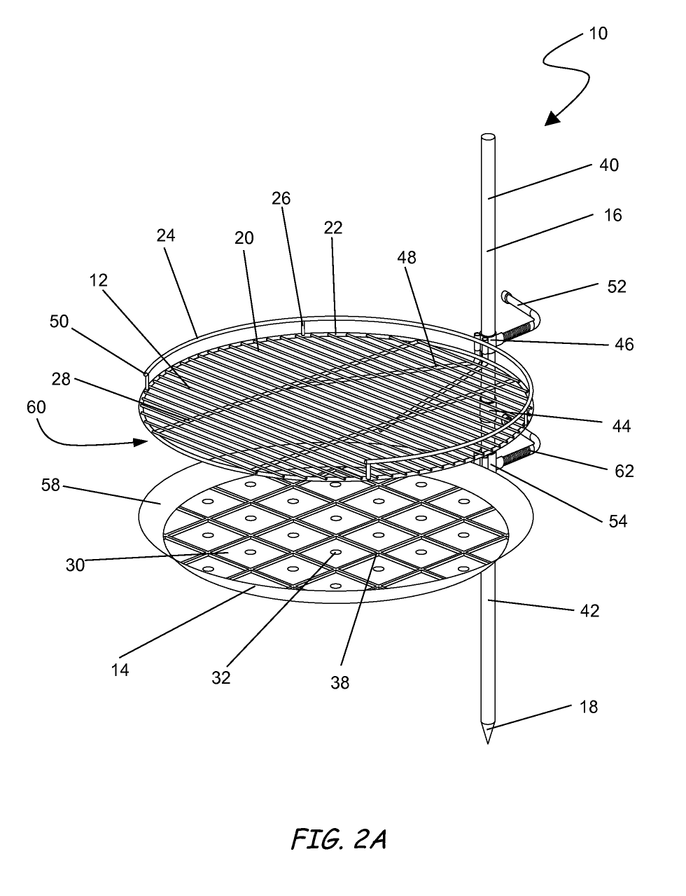

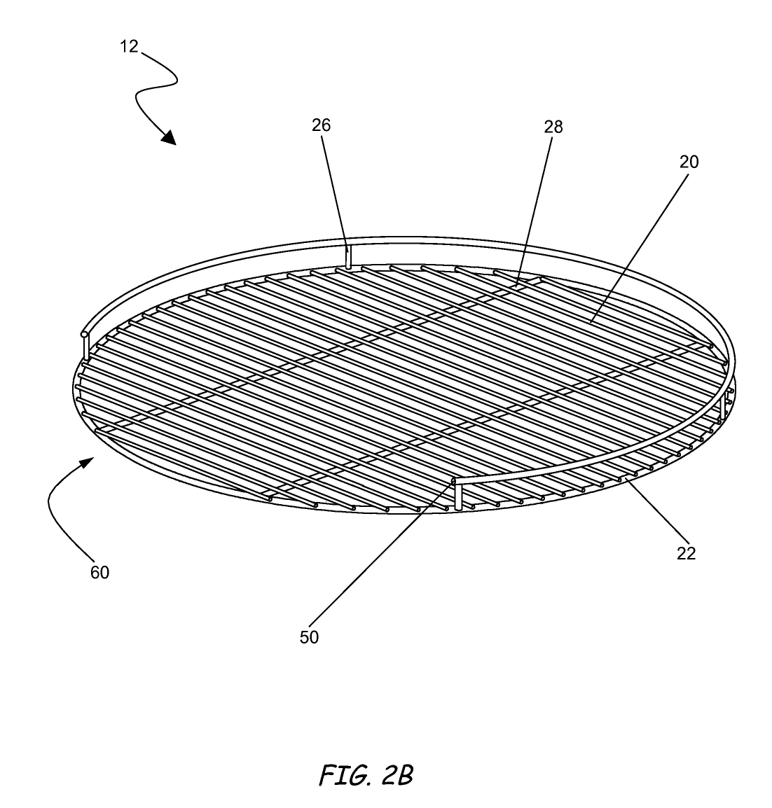

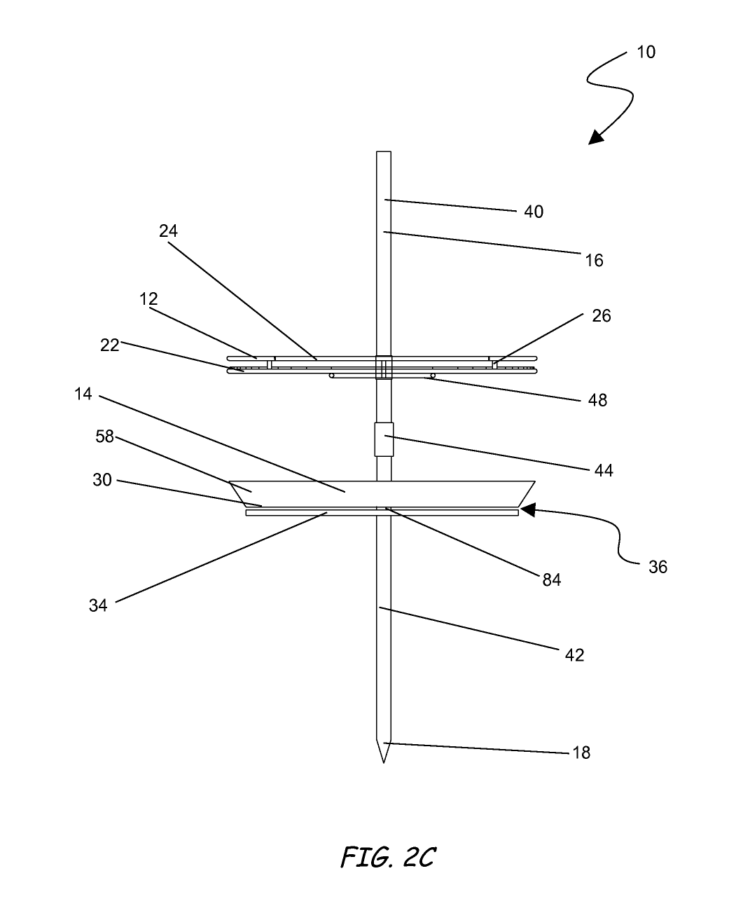

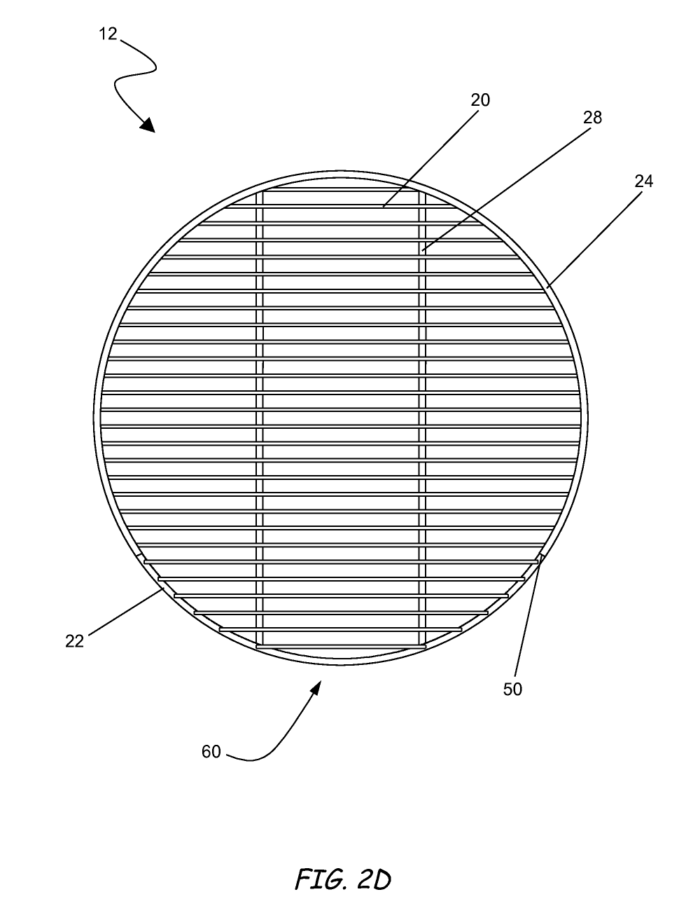

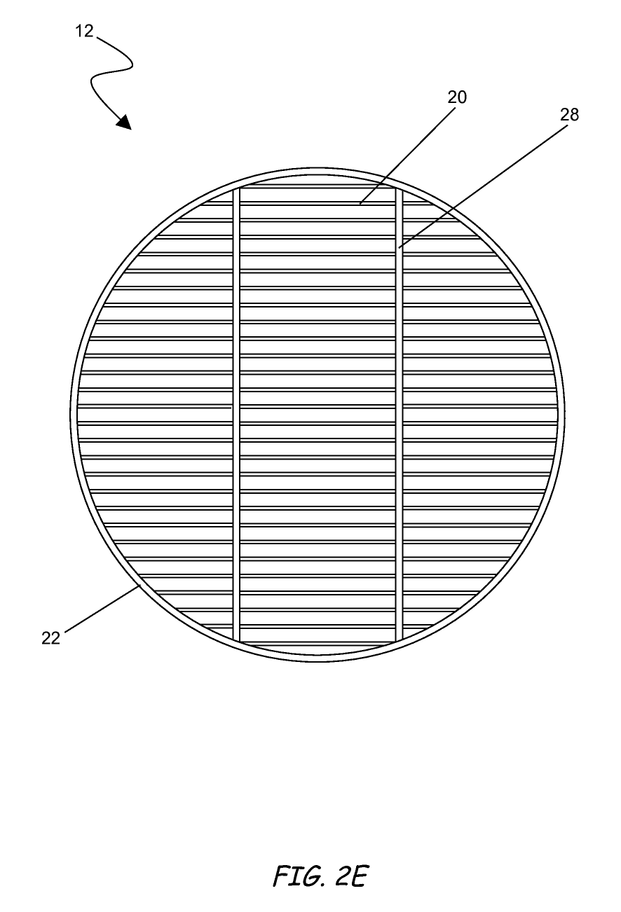

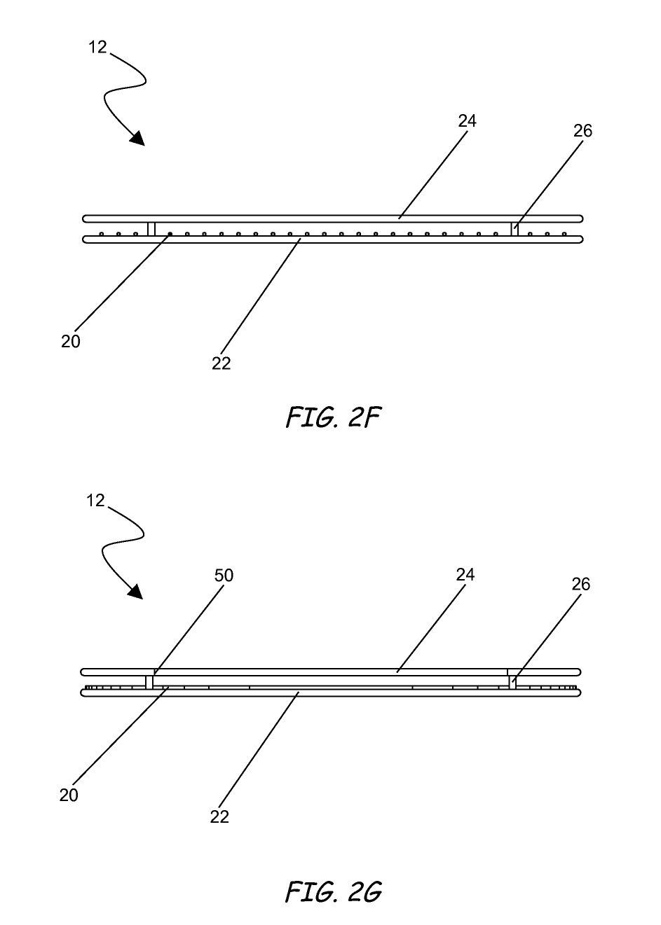

A portable grill assembly 10 is illustrated in FIGS. 1A, 2A and 2C. Grill assembly 10 may be used to contain and elevate a fire off the ground that is to be used for cooking, heating, lighting and other uses. Because of the risk of wild fires that may be enhanced by severe droughts in many parts of the world, many government entities may require that outdoor, open fires be contained and elevated off the ground to aid in the prevention of the wild fires that may cause great damage to many thousands of acres throughout a region.

Portable grill assembly 10 includes a grill grate 12 and fire tray 14. Fire tray 14 is generally positioned under grate 12 such that any fire contained by fire tray 14 will heat and cook any liquid and food placed upon grate 12. Grill assembly 10 further includes a mounting stake 16 that may be used to secure and position grate 12 and tray 14. Furthermore, mounting stake 16 may include a pointed end 18. Generally, the pointed end of any stake is used to penetrate the ground as the stake is anchored to the ground. Pointed end 18 may aid one in driving mounting stake 16 into the ground to anchor grill assembly 10.

Grill grate 12 may be structured in a typical fashion having multiple rods 20 that are secured to an outer edge dowel 22 as illustrated in FIGS. 1A-2G. Typically, rods 20 extend from one side of outer edge dowel 22 and are generally arranged parallel to one another. Rods 20 may be evenly spaced to provide support for an item such as food so that the food does not fall through rods 20 yet they are sufficiently spaced so that the heat from the fire below may pass through to the food. It is important to note, however, that any type of grill surface may be suitable for use with grill assembly 10. These other types of grill surfaces may include solid surfaces as well as surfaces with apertures that may be shaped as diamonds, circles and triangles and the like.

Grate 12 may also include a raised edge dowel 24 that is positioned and secured above outer edge dowel 22 by a plurality of posts 26 that may extend generally upward from outer edge dowel 22. Upper edge dowel 24 may be positioned and secured in this manner to help ensure that some types of food, such as hot dogs, sausage and the like (i.e. foods that are generally cylindrical in shape) that have a tendency to roll about a grill, remain on the grill while being heated.

Upper edge dowel 24 may extend around the entire perimeter of grate 12 or, alternatively, upper edge dowel 24 may extend partially around the perimeter of grate 12 as illustrated in FIGS. 1A-2B. Extending upper edge dowel 24 partially around the perimeter of grate 12 enables a opening 60 to allow for an easier use of kitchen utensils, such as a spatula and the like, to engage and turn foods over, such as hamburgers, to cook both sides. An upper edge dowel 24 that extends the entire perimeter of grate 12 will ensure that the round foods described above, such as sausage, are maintained on the grill, but upper edge dowel 24, when used in this manner, may hinder the use of kitchen utensils such as the spatula.

Upper edge dowel 24 may end at a termination 50 that may extend and connect to outer edge dowel 22 as illustrated in FIGS. 1A and 1B or end at a termination 50 that that extends just past posts 26 as shown in FIGS. 2A-2D and 2G. The terminations 50 work collectively with grate 12 to create opening 60 to enable the easier use of the kitchen utensils described above.

Grate 12 may further include support dowels 28 that extend under rods 20 from one side of outer edge dowel 22 to a second side of outer edge dowel 22. Support dowels 28 are typically spaced apart from one another as depicted in the drawings to provide support for rods 20 and any food or cooking vessels that may be placed on grate 12. Dowels 28 are also positioned such that they perpendicularly intersect rods 20 to provide even further support for rods 20.

Grate 12 may also include a first sleeve 46 and anchor rods 48. Sleeve 46 may be assembled to grate 12 at outer edge dowel 22 and upper edge dowel 24. Anchor rods 48 may extend from sleeve 46 and under grate 12 and rods 20 to provide further support to grate 12 and further secure sleeve 46 to grate 12. Sleeve 46 may be designed such that the inside diameter of sleeve 46 is slightly larger than the outside diameter of stake 16. With sleeve 46 sized in this manner, sleeve 46 may be slid onto stake 16 and may slide freely about the length of stake 16.

Sleeve 46 includes a threaded hole 50 that is sized to accept a bolt 52. Hole 50 may be positioned in a side wall of sleeve 46 such that when bolt 52 is fed into hole 50, and stake 16 is positioned in sleeve 46, bolt 52 will engage a surface of stake 16. As bolt 52 continues to be fed through hole 50, the exterior surface of stake 16 will engage the interior surface of sleeve 46. When ample force is applied between bolt 52, sleeve 46 and stake 16, grate 12 will be secured to stake 16 and ready for cooking In this particular embodiment of the present invention, bolt 52 is illustrated in the shape of an 1′ and may be designed in this manner to allow one to grasp bolt 52 with their hand and turn easily. Although bolt 52 is shown in the shape of an ‘L’, it is important to note, however, that bolt 52 may be any shape and still be used to secure grate 12 to stake 16.

Grate 12 may be manufactured of any materials that are capable of withstanding the temperatures generated by fires produced from wood or charcoal and used for cooking foods and heating liquids. Typically, many types of grill grates are manufactured from metals such as stainless steel. Stainless steel can be very durable against the heat that is created by fires from wood, charcoal and the like, while also withstanding the rust effects brought on by air and water. The separate pieces of grate 12 (edge dowels 22 and 24, rods 20, posts 26, dowels 28, sleeve 46 and anchor rods 48) may all be assembled with typical welding means such that the assembly can with stand the high temperatures, multiple uses and storage for periods of time.

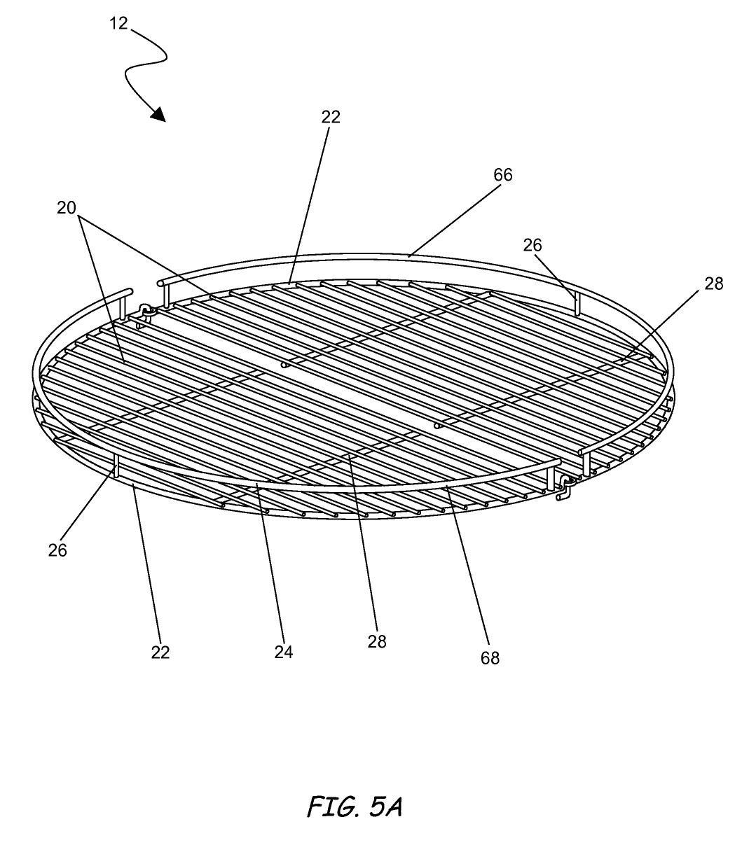

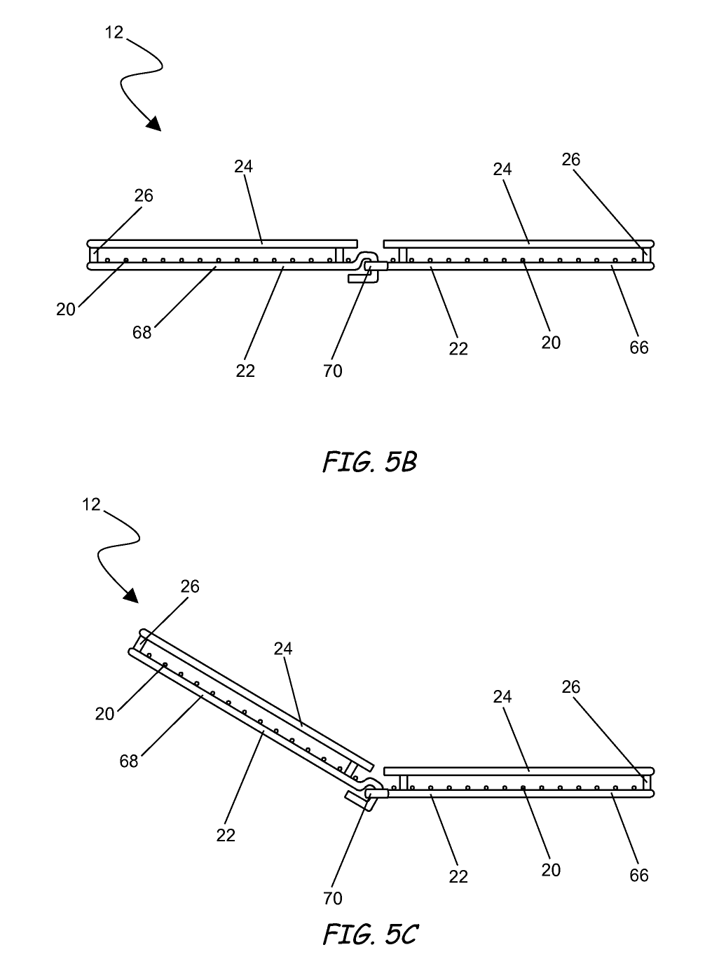

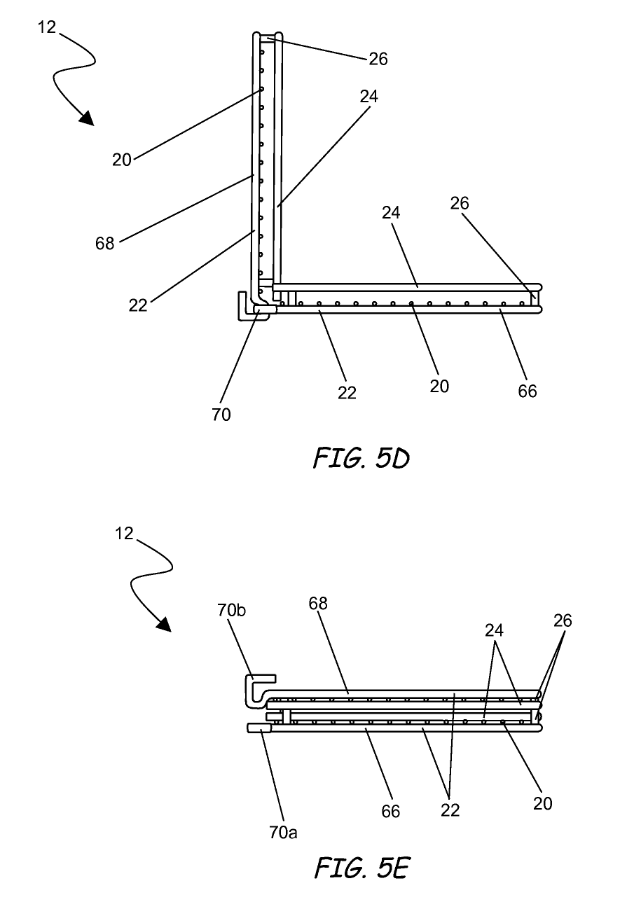

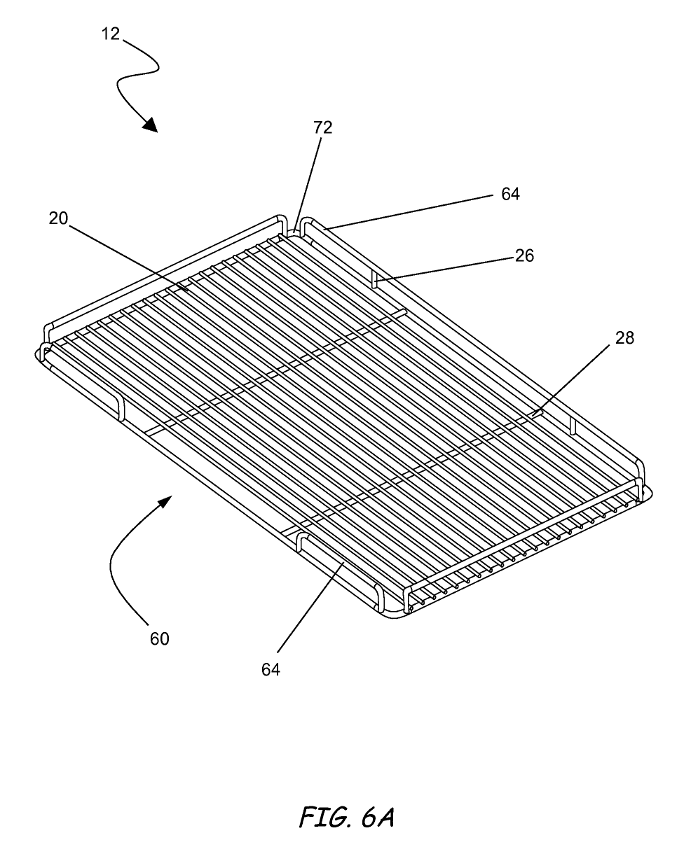

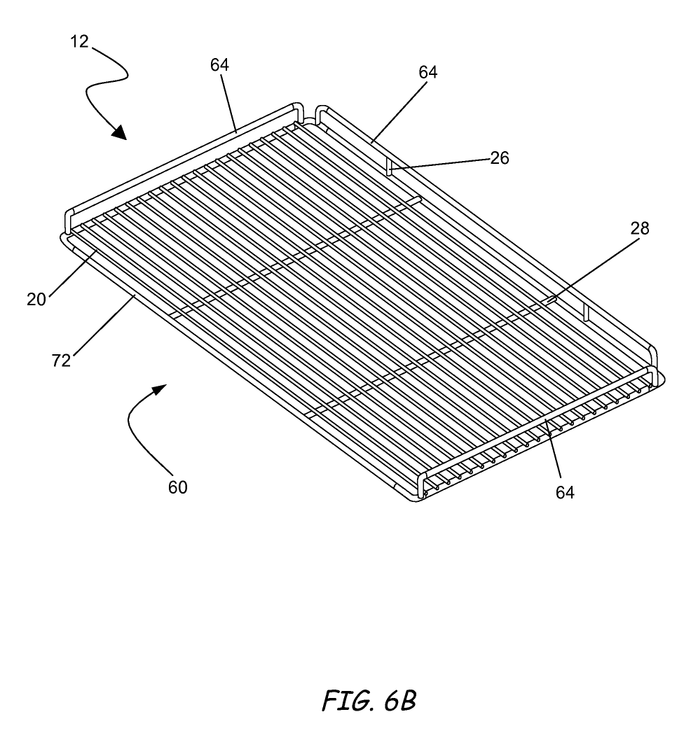

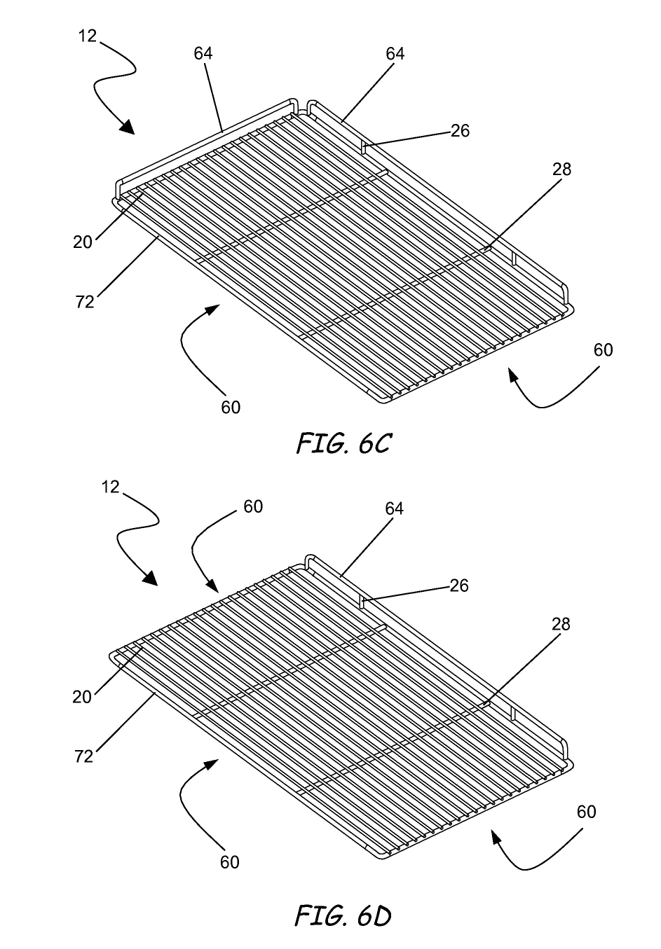

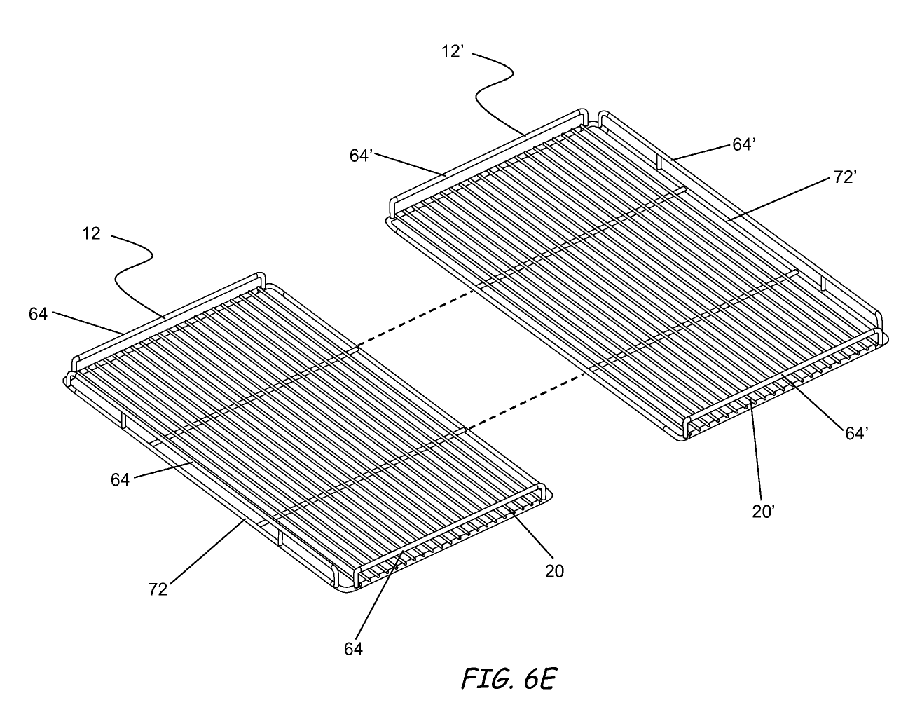

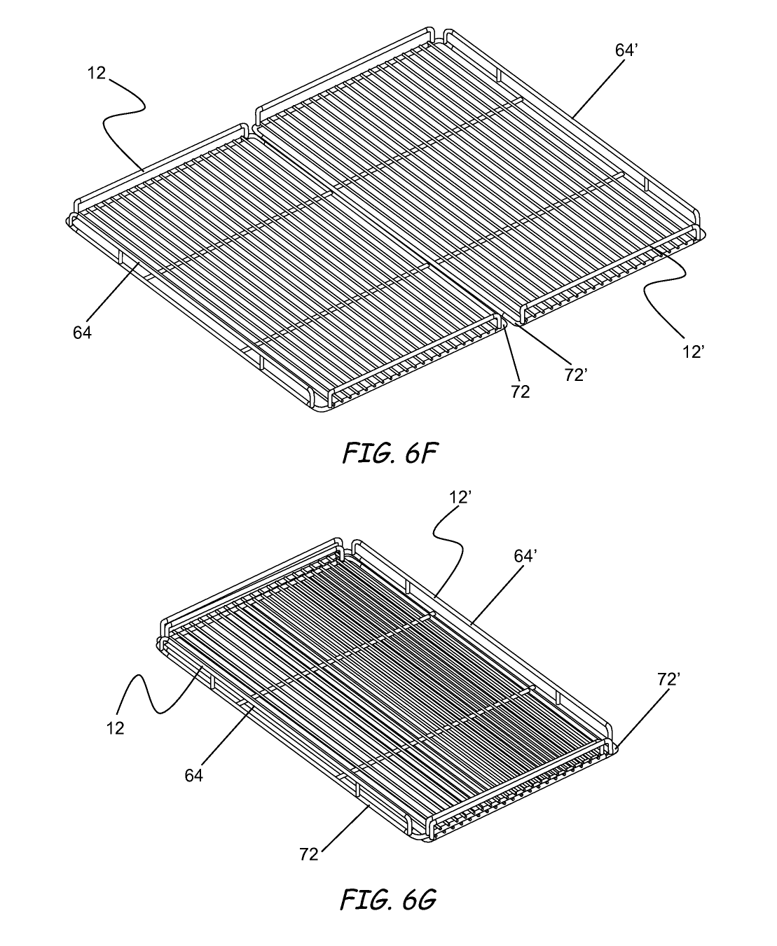

Grate 12 may be manufactured in any shape as well. A circular shape has been described above and illustrated in the drawings thus far. Other shapes may include square or rectangle as illustrated in FIGS. 6A-6G. In this particular embodiment of the present invention, the rectangular shaped grill grate 12 may be structured in the same manner as described above for a circular grill grate. Multiple rods 20 may be secured to an outer perimeter edge dowel 72 as illustrated in FIGS. 5A-5G. Typically, rods 20 extend from one side of edge dowel 72 and are generally arranged parallel to one another. Rods 20 may be evenly spaced to provide support for an item such as food so that the food does not fall through rods 20 yet they are sufficiently spaced so that the heat from the fire below may pass through to the food. Still other shapes may include oval, triangle, trapezoidal and the like.

Rectangular grate 12 may also include a raised edge dowel 64 that is positioned and secured above edge dowel 72 by a plurality of posts 26 that may extend generally upward from edge dowel 72. Raised edge dowel 64 may be positioned and secured in this manner to help ensure that some types of food, such as hot dogs, sausage and the like (i.e. foods that are generally cylindrical in shape) that have a tendency to roll about a grill, remain on the grill while being heated.

Raised edge dowel 64 may extend around the entire perimeter of grate 12 or, alternatively, raised edge dowel 64 may extend partially around the perimeter of grate 12 as illustrated in FIGS. 1A-2G. Extending raised edge dowel 64 partially around the perimeter of grate 12 enables a opening 60 to allow for an easier use of kitchen utensils, such as a spatula and the like, to engage and turn foods over, such as hamburgers, to cook both sides. Raised edge dowel 64 that extends the entire perimeter of grate 12 will ensure that the round foods described above, such as sausage, are maintained on the grill, but raised edge dowel 64, when used in this manner, may hinder the use of kitchen utensils such as the spatula.

Rectangular grate 12 may further include support dowels 28 that extend under rods 20 from one side of outer edge dowel 72 to a second side of outer edge dowel 72. Support dowels 28 are typically spaced apart from one another as depicted in the drawings to provide support for rods 20 and any food or cooking vessels that may be placed on grate 12. Support dowels 28 are also positioned such that they perpendicularly intersect rods 20 to provide even further support for rods 20.

Fire tray 14 is round in shape and is generally positioned under grate 12 as depicted in FIGS. 1A, 2A and 2C. Tray 14 includes a bottom surface 30 that includes a multitude of holes 32. Tray 14 further includes a wall 58 that extends generally upward and outward from bottom surface 30 to form the upper section of tray 14. Wall 58 may be designed in this manner to capture fuel and any ash produced by the combustion process during the burning of the fuel.

As illustrated by FIG. 2C, tray 14 further includes a plate 34 that may be positioned under and secured to bottom surface 30 by a single post 84. Post 84 is positioned at the center of tray 14 and plate 34. Plate 34 may be positioned relative to bottom surface 30 such that a gap 36 may be created to allow the flow of oxygen to enter gap 36 and exit through holes 32. Bottom surface 30 may also include a grid pattern 38. Grid 38 may be sized such that holes 32 are not blocked as fuel such as wood and the like is added to tray 14. Grid 38 act will act to elevate the fuel above surface 30 such that the air being drawn in through gap 36 can escape through holes 32 when fuel is loaded in tray 14. The constant flow of air though gap 36 and holes 32 will ensure that a constant and even fire may be created for optimal cooking and heating conditions.

Tray 14 includes a second sleeve 54 and anchor rods 56. Sleeve 54 may be assembled to tray 14 at wall 58 with anchor rods 56 extending from sleeve 54 and under plate 34 of tray 14 to provide support to tray 14 and further secure sleeve 54 to tray 14. In the same manner as described above for grill grate 12, sleeve 54 may be designed such that the inside diameter of sleeve 54 is slightly larger than the outside diameter of stake 16. With sleeve 54 sized in this manner, sleeve 54 may be slid onto stake 16 and may slide freely about the length of stake 16.

Sleeve 54 also includes a threaded hole 60 that is sized to accept a bolt 62. Hole 60 may be positioned in a side wall of sleeve 54 such that when bolt 62 is fed into hole 60, and stake 16 is positioned in sleeve 54, bolt 62 will engage a surface of stake 16. As bolt 62 continues to be fed through hole 60, the exterior surface of stake 16 will engage the interior surface of sleeve 54. When ample force is applied between bolt 62, sleeve 54 and stake 16, tray 14 will be secured to stake 16 and ready for cooking In this particular embodiment of the present invention, bolt 62 is illustrated in the shape of an ‘L’ and may be designed in this manner to allow one to grasp bolt 62 with their hand and turn easily. Although bolt 62 is shown in the shape of an ‘L’, it is important to note, however, that bolt 62 may be any shape and still be used to secure tray 14 to stake 16.

Tray 14 may be manufactured of any materials such as metals, ceramics and the like, that are capable of withstanding the high temperatures generated from the fire produced by the chosen fuel. Tray 14 along with grate 12 are designed to be used on multiple occasions for the cooking and heating of food and liquids, so the materials should be capable of withstanding the high temperatures as well as the elements of air and water.

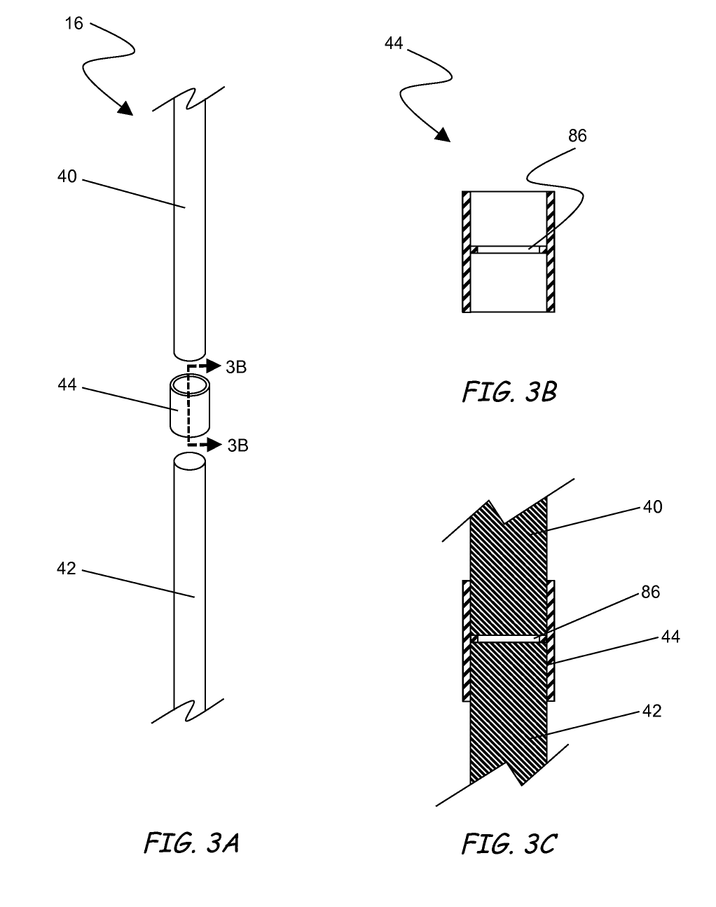

In this particular embodiment of the present invention, mounting stake 16 is illustrated as two separate pieces in FIGS. 3A-3C. Mounting stake 16 includes a top segment 40 and a bottom segment 42. A coupler 44 is included as well as a means to assemble top segment 40 with bottom segment 42 to create mounting stake 16. Coupler 44 may be a simple sleeve that includes a lip 86 on the interior surface of coupler 44 to serve as a stop. Lip 86 will be designed such that the interior diameter of lip 86 is smaller than the exterior diameter of top segment 40 and bottom segment 42. Top segment 40 will stop at lip 86 as top segment 40 enters a first end of coupler 44 and bottom segment 42 will stop at lip as bottom segment 42 enters an opposite end of coupler 44. Coupler 44 will position and secure top segment 40 and bottom segment 42 to create mounting stake 16.

Alternatively, coupler 44 may include a threaded interior wall. Top segment 40 and bottom segment 42 may include a threaded section for engaging the threaded walls of coupler 44. Top segment 40 and bottom segment 42 may be screwed into opposite ends of coupler 44 to provide for a more positive securement of stake 16. No matter the means of assembly, mounting stake 16 may be designed as two separate pieces for ease of storage and package while at the same time minimizing the number of pieces for assembly. However, it is important to note, the mounting stake 16 may be designed to be a single piece, or, alternatively, stake 16 may include a number of segments and couplers that require assembly, yet still maintain the same concepts of the invention as described above.

Portable grill assembly 10 may be assembled in the following manner upon arrival to a campsite, tailgate, picnic area and the like. Top segment 40 may be assembled to bottom segment 42 at coupler 44 to fully assemble stake 16. With stake 16 fully assembled, first sleeve 46 of grill grate 12 may engage stake 16 and grate 12 may be positioned about stake 16 by sliding sleeve 46 about stake 16 until the desired position is located. Once positioned, bolt 52 may be introduced to threaded hole 50 and bolt 52 may be rotated within hole 50 until bolt 52 engages stake 16 and provides enough force to secure sleeve 46 and grate 12 to stake 16.

Fire tray 14 may be assembled in much the same manner to stake 16. Second sleeve 54 of fire tray 14 may engage stake 16 and tray 14 may be positioned about stake 16 by sliding sleeve 54 about stake 16 until the desired position is located. Once positioned, bolt 62 may be introduced to threaded hole 60 and bolt 62 may be rotated within hole 60 until bolt 62 engages stake 16 and provides enough force to secure sleeve 54 and tray 14 to stake 16. Ideally, tray 14 will be positioned below grate 12 such that any fuel added to tray 14 may be lit to create a fire that will cook or heat the food or liquids above the fire and positioned on grate 12.

With portable grill assembly 10 fully assembled, grill 10 may be secured in the ground by driving pointed end 18 of stake 16 into the ground such that grill 10 will positioned upright and ready for cooking In this position, grate 12 and tray 14 will be positioned relatively parallel or level to the ground such that any fuel added to tray 14 and any food or cooking vessels added to grate 14 will not roll or slide off tray 14 or grate 12.

Any type of fuel such as wood, charcoal and the like may be added to fire tray 14 and a fire may be started. Oxygen may flow through gap 36 and holes 32 to aid the combustion process so that the fire may provide an even temperature for cooking Depending on the temperature level required, the positioning between grate 12 and tray 14 may be changed to raise or lower the temperature at the surface of grate 12. Bolts 52 and 62 may be rotated such that sleeves 46 and 54 may be allowed to slide freely about stake 16 once again. The ability to position and reposition grate 12 and tray 14 relative to one another will allow one to vary the cooking temperatures at grate 14. This is advantageous because different types of food cook at different times and different temperatures, therefore providing for a means of ensuring that all food may be cooked to meet specifications for taste and preference and more importantly to ensure that all food is cooked to a safe temperature for consumption.

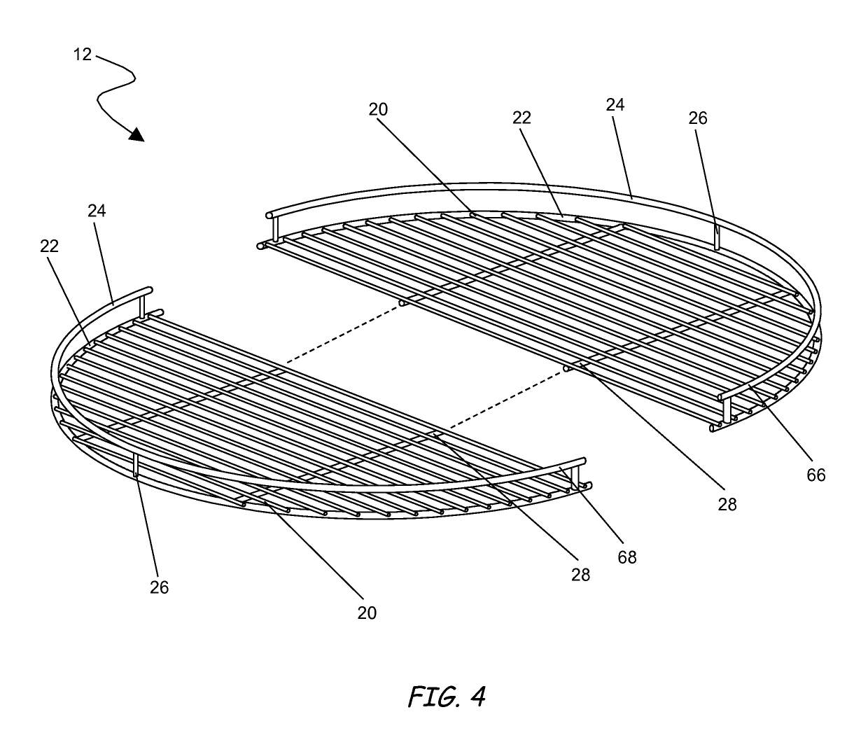

In another embodiment of the present invention, circular grill grate 12 may be split in a first half 66 and a second half 68 as illustrated in FIG. 4. Having two halves of grill grate 12 will enable ease of stowage when grill grate 12 is not in use. One half 66 of grill grate 12 may be placed within the other half 68 to minimize the size of grill grate 12 (See e.g. FIG. 6G) during travel or storage at home. When in use, the two halves of grate 12 can be placed next to one another along the long edges of rods 20 to create the circular grate 12 for cooking Alternatively, if a small meal needs to be heated or one is in a confined space or area, only one half of grate 12 may be used.

FIGS. 5A-5E illustrate yet another embodiment of the present invention. In this particular embodiment, a hinge assembly 70 may be added to grate 12 to connect the two halves of grate 12. Outer edge dowel 22 includes a loop 70a of first half 66 and a hook 70b of second half 68. Loop 70a and hook 70b cooperatively create hinge assembly 70 when hook 70b is secured to loop 70a to connect first half 68 and second half 66 of grill grate 12. Hinge assembly 70 ensures that both halves 66 and 68 of grill grate 12 will stay connected while in use during the cooking process. Hinge assembly 70 will also allow first half 66 and second half 68 of grate 12 to be moved to any position relative to either half as illustrated in FIGS. 5C and 5D. Loop 70a and hook 70b of hinge assembly 70 may be disconnected as shown in FIG. 5E so that second half 68 may be folded into first half 66 for ease of stowage.

FIGS. 6B-6D illustrate still further another embodiment of the present invention. In this particular embodiment, rectangular grill grate 12 may include any number of raised edge dowels 64 that may be used to enable a wide variety of cooking uses. As mentioned above, while raised edge dowels 64 are desirable on all sides to ensure that any food or cooking vessels are maintained on grate 12, raised edge dowels 64 may be a hindrance when specific cooking utensils are in use, such as a spatula used to flip a hamburger.

Furthermore, multiple rectangular grill grates 12 and 12′ may be aligned together as illustrated in FIGS. 6E and 6F to create a larger cooking surface. Edge dowels 72 and 72′ as well as raised edge dowels 64 and 64′ and rods 20 and 20′ can be aligned to ensure that grates 12 and 12′ are properly and safely set up for cooking Hinge assembly 70 discussed above may be added to rectangular grill grates 12 and 12′ (not shown) as well to help ensure grates 12 and 12′ stay connected while in use. After cooking on grates 12 has ended and grates 12 are properly cooled, rectangular grill grates 12 and 12′ may be nested within each other as illustrated in FIG. 5G for stowage during travel or storage at home while not in use.

The present invention has been particularly shown and described with reference to the foregoing embodiment, which is merely illustrative of the best modes presently known for carrying out the invention. It should be understood by those skilled in the art that various alternatives to the embodiment of the invention described herein may be employed in practicing the invention without departing from the spirit and scope of the invention as defined in the following claims. It is intended that the following claims define the scope of the invention and that the method within the scope of these claims and their equivalents be covered thereby. This description of the invention should be understood to include all novel and non-obvious combination of elements described herein, and claims may be presented in this or a later application to any novel non-obvious combination of these elements. Moreover, the foregoing embodiment is illustrative, and no single feature or element is essential to all possible combinations that may be claimed in this or a later application.

What is claimed is:

1. A raised edge grill grate comprising:
an outer edge dowel that extends near a perimeter of said grill grate;
a plurality of rods extending generally horizontally and generally parallel to one another and intersecting said outer edge dowel of said grill grate, said plurality of rods positioned such that there is sufficient space between said plurality of rods to support food and cooking vessels over a heating element;
at least one raised edge dowel that extends near said outer edge dowel of said grill grate and is positioned a distance above said outer edge dowel to capture the food and the cooking vessels on said grill grate;
a plurality of posts that extend generally vertically from said outer edge dowel and fixedly connect said outer edge dowel to said at least one raised edge dowel; and
wherein said at least one raised edge dowel extends partially around the perimeter of said grill grate to create an opening.

2. The raised edge grill grate as recited in claim 1, wherein said raised edge grill grate is generally circular in shape.

3. The raised edge grill grate as recited in claim 1, wherein said raised edge grill grate is generally rectangular in shape.

4. The raised edge grill grate as recited in claim 1, wherein said outer edge dowel includes at least one hook and at least one loop, said at least one hook and said at least one loop cooperatively create at least one hinge assembly.

5. The raised edge grill grate as recited in claim 1, wherein said raised grill grate is comprised of two separate raised grill grates, a first half grill grate and second half grill grate.

6. The raised edge grill grate as recited in claim 5, wherein said first half grill grate is sized to be positioned on said second half grill grate and nest within said at least one raised edge of said second half grill grate.

7. The raised edge grill grate as recited in claim 1, wherein said at least one raised edge dowel includes at least one termination that is fixedly connected to said outer edge dowel.

8. The raised edge grill grate as recited in claim 1, wherein said at least one raised edge dowel includes at least one termination that extends past said post.

9. A portable grill assembly comprising:
a raised edge grill grate; said raised edge grill grate comprising:
an outer edge dowel that extends near a perimeter of said grill grate;
a plurality of rods extending generally horizontally and generally parallel to one another and intersecting said outer edge dowel of said grill grate, said plurality of rods positioned such that there is sufficient space between said plurality of rods to support food and cooking vessels over a heating element;
at least one raised edge dowel that extends near said outer edge dowel of said grill grate and is positioned a distance above said outer edge dowel to capture the food and the cooking vessels on said grill grate;
a plurality of posts that extend generally vertically from said outer edge dowel and fixedly connect said outer edge dowel to said at least one raised edge dowel; and
wherein said at least one raised edge dowel extends partially around the perimeter of said grill grate to create an opening;
a fire tray, said fire tray including:
a plurality of holes, said holes configured to allow the flow of oxygen into said fire tray;
a plate, said plate configured to be secured to a bottom surface of said fire tray by a single post, said post being positioned at the center of said plate and said bottom surface;
a gap, said gap being created between said plate and said bottom surface of said fire tray by a length of said post to enable a uniform flow of oxygen to pass through said gap on all sides of said fire tray into said holes; and
a grid pattern, said grid pattern being integrated within said bottom surface of said fire tray and configured to extend upward from said bottom surface of said fire tray such that a fuel is elevated over said holes to enable a uniform flow of oxygen through said gap, said holes and to the fuel;
a support stake, said support stake including at least one coupler configured to secure multiple sections of said support stake, said coupler including a lip, said lip configured within the interior diameter of said coupler to prevent movement of sections of said support stake relative to said coupler; and
wherein said support stake is configured to secure and position said fire tray a distance above the ground and said support stake is configured to secure and position said grill grate a distance above said fire tray.

10. The portable grill assembly as recited in claim 9, wherein said raised edge grill grate is generally circular in shape.

11. The portable grill assembly as recited in claim 9, wherein said raised edge grill grate is generally rectangular in shape.

12. The portable grill assembly as recited in claim 9, wherein said outer edge dowel includes at least one hook and at least one loop, said at least one hook and said at least one loop cooperatively create at least one hinge assembly.

13. The portable grill assembly as recited in claim 9, wherein said raised grill grate is comprised of two separate raised grill grates, a first half grill grate and second half grill grate.

14. The raised edge grill grate as recited in claim 13, wherein said first half grill grate is sized to be positioned on said second half grill grate and nest within said at least one raised edge of said second half grill grate.

15. The raised edge grill grate as recited in claim 9, wherein said at least one raised edge dowel includes at least one termination that is fixedly connected to said outer edge dowel.

16. The raised edge grill grate as recited in claim 9, wherein said at least one raised edge dowel includes at least one termination that extends past said post.
